(19) United States
(12) Patent Application Publication
(10) Pub. No.: US 2015/0020308 A1
(43) Pub. Date: Jan. 22, 2015

(54) INFANT ACCESSORY WITH VIBRATION SYSTEM

(71) Applicant: Sheila Reichle, Zephyr Cove, NV (US)

(72) Inventor: Sheila Reichle, Zephyr Cove, NV (US)

(21) Appl. No.: 14/302,984

(22) Filed: Jun. 12, 2014

Related U.S. Application Data
(60) Provisional application No. 61/835,029, filed on Jun. 14, 2013.

(51) Int. Cl. A47D 15/00; B60N 2/26; B60N 2/44

(52) U.S. Cl. CPC A47D 15/00; B60N 2/44; B60N 2/26
USPC 5/93.1; 297/217.3

(57) ABSTRACT

An apparatus has an accessory for a child. The accessory has at least one structural element. A vibration element is secured to the at least one structural element. A controller is in communication with the vibration element for controlling the vibration element. A power source for powering at least one of the controller and the vibration element in included.

### CROSS-REFERENCE TO RELATED APPLICATIONS

This application claims priority to and the benefit of U.S. Provisional Application Ser. No. 61/835,029, entitled “INFANT CAR SEAT WITH VIBRATION ELEMENT,” filed Jun. 14, 2013, the disclosure of which is hereby incorporated by reference in its entirety.

### INTRODUCTION

Various devices exist that allow babies and infants to be stimulated while in a relatively stationary position. Such devices include bouncy seats, baby walkers, rocking cradles, mechanized swings, etc. Certain of these devices (bouncy seats, baby walkers) provide a significant amount of stimulation, but may not help soothe a restless or overtired infant. Rocking cradles and mechanized swings may provide just enough soothing motion, but are often bulky and not easily transported. Additionally, all of these devices can cost a significant amount of money, thus putting a strain on already tight family budgets.

### SUMMARY

The technology relates to an infant car seat or other accessory having a vibration system attached thereto. The vibration system includes a vibration element that may be battery-powered or connected to a power supply and produces a gentle vibration throughout the accessory when in operation. This vibration may help keep infants soothed while seated. In one aspect, the technology relates to an apparatus having: an accessory for a child, the accessory having at least one structural element; a vibration element secured to the at least one structural element; a controller in communication with the vibration element for controlling the vibration element; and a power source for powering at least one of the controller and the vibration element. In an embodiment, the accessory includes a car seat, a play space, a blanket, a crib, and a stroller. In another embodiment, the vibration element has at least one motor. In yet another embodiment, the controller is disposed on the vibration element. In still another embodiment, the controller is disposed remote of the vibration element.

In another embodiment of the above aspect, the accessory has a controller attachment element for attaching the controller to the accessory. In an embodiment, the controller is removably attachable to the controller attachment element. In another embodiment, the accessory has a vibration element bracket. In yet another embodiment, the vibration element is removably attachable to the vibration element bracket. In still another embodiment, the structure has at least one structural element including a body, a strut, a handle, a leg, and a base.

In another embodiment of the above aspect, the controller is disposed on an underside of the accessory. In an embodiment, the controller has a timer. In another embodiment, the controller includes a variable speed controller.

In another aspect, the technology relates to a car seat adapted to receive a child and to be secured within a passenger compartment of a vehicle; a motor disposed in the car seat; and a controller for actuating the motor. In an embodiment, the controller is disposed in a location of the car seat that is generally inaccessible to the child when the child is received in the car seat. In another embodiment, the location is at least one of an underside of the car seat, on a handle of the car seat, and remote from the car seat. In yet another embodiment, the controller is in communication with the motor via a wireless connection. In still another embodiment, the apparatus includes a battery for providing power to at least one of the controller and the motor. In yet another embodiment, the motor is completely inaccessible to the child when the child is received in the car seat.

In another aspect, the technology relates to a method of exerting a stimulation on a child disposed in a car seat, the method comprising: receiving the child in the car seat; receiving a control signal at a component of the car seat; and actuating a motor disposed in the car seat.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 depicts an infant car seat having a vibration system, in accordance with several aspects of the technology.

FIG. 2 depicts an infant accessory having a vibration system, in accordance with another aspect of the technology.

FIGS. 3A-3C depict attachment mechanisms for vibration systems.

FIG. 4 illustrates one example of a suitable operating environment which one or more of the aspects of the disclosure may be implemented.

### DETAILED DESCRIPTION

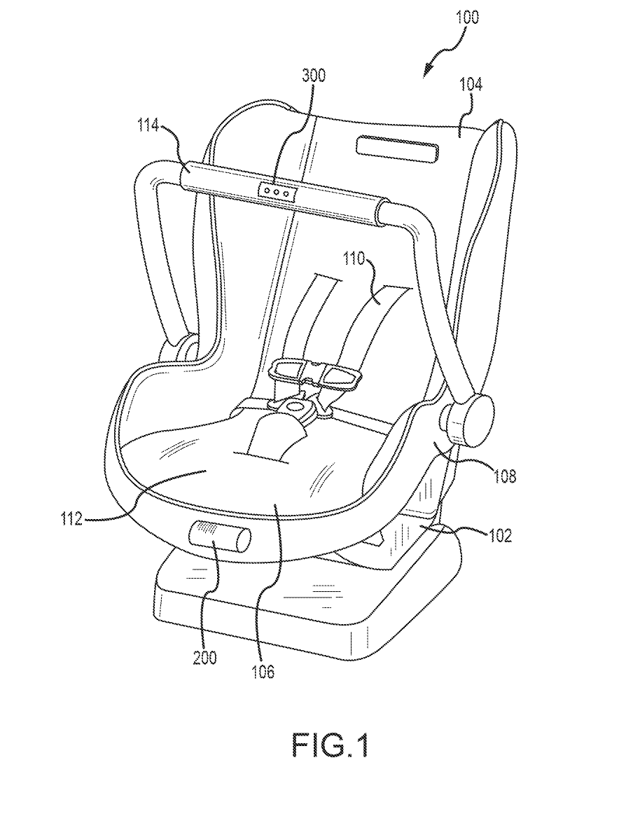

FIG. 1 depicts an infant car seat having a vibration system, in accordance with several aspects of the technology. More particularly, FIG. 1 depicts various locations of an infant seat 100 upon which a vibration element 200 may be disposed. The infant car seat 100 includes, in the depicted embodiment, a number of structural components including a base portion 102, a headrest 104, a footrest 106, and sidewalls 108. These portions generally make of the portion of the car seat 100 that receives an infant such that the infant may be secured therein by straps 110. The infant rests on a cushioned surface 112. The car seat 100 also includes a handle 114 by which the car seat 100 may be carried. The various structural components of the car seat 100 are generally manufactured to rigid plastics and provide a firm base for support of the infant.

The vibration element 200 may be a motor or other element that generates a vibrational stimulus and is secured to a structural component of the car seat 100. The structural component can be any of the components listed above, other components of the car seat 100, or sub-components of said components (e.g., a strut or rib that spans one or more components to provide rigidity thereto). By disposing the vibration element 200 on the rigid structural component, vibrational stimuli produced by the vibration element 200 is transmitted through the car seat 100 to provide a soothing sensation to the child lying therein.

In general, it may be desirable that the vibration element 200 is completely inaccessible to the infant when the infant is disposed in the car seat 100. Depending on the length and flexibility of the infant's limbs, this may necessitate location of the vibration element 200 on an underside of the car seat 100 or enclosed within a component thereof. In another embodiment, the vibration element 200 may be disposed beneath a cover located on the car seat 100. Although the vibration element 200 may be disposed virtually anywhere on the car seat 100, it may be desirable to locate the vibration element 200 centrally on the infant car seat 100, for example, on a sidewall 108, carrying handle 114, or below the seat 100, such that the vibrations are evenly dispersed therethrough. If disposed proximate the headrest 104 or footrest 102, the vibrations may dissipate before reaching the opposite end of the car seat 100. Additionally, locating the vibration element 200 proximate the headrest 104 may result in excessive noise or vibrations near the infant's head.

The controller 300 may be disposed on or remote from the vibration element 200. It may be desirable to locate the controller 300 such that the infant is unable to tamper with the associated controls. Additionally, the controller 300 should be located such that it is not inadvertently activated or deactivated. For example, infant car seats are typically placed in a rear-facing position in the back seat of a car. In that case, the footrest 106 may contact the backrest of the back seat or the headrest 104 may contact the rear of the front seat. Accordingly, certain structures as described below may be utilized to prevent the controller 300 located thereon from being inadvertently activated. FIG. 1 depicts the controller 300 disposed remote from the vibrator element 200. The controller 300 may be located in a location less likely to be inadvertently contacted (e.g., the handle 114). If a controller 300 is located discrete from the vibration element 200, control signals may be sent via a wired or wireless connection. One such embodiment includes the vibration element 200 disposed below the base portion 102 such that it cannot be accessed by the infant. A controller 300 may be integrated with an upper portion of the handle 114 so as to limit tampering. Control wiring may be disposed within the handle 114 from the controller 300 to the vibration element 200. Although multiple configurations are described herein, FIG. 1 depicts the vibration element 200 disposed proximate the footrest 106 and the controller 300 located remote therefrom on the handle 114.

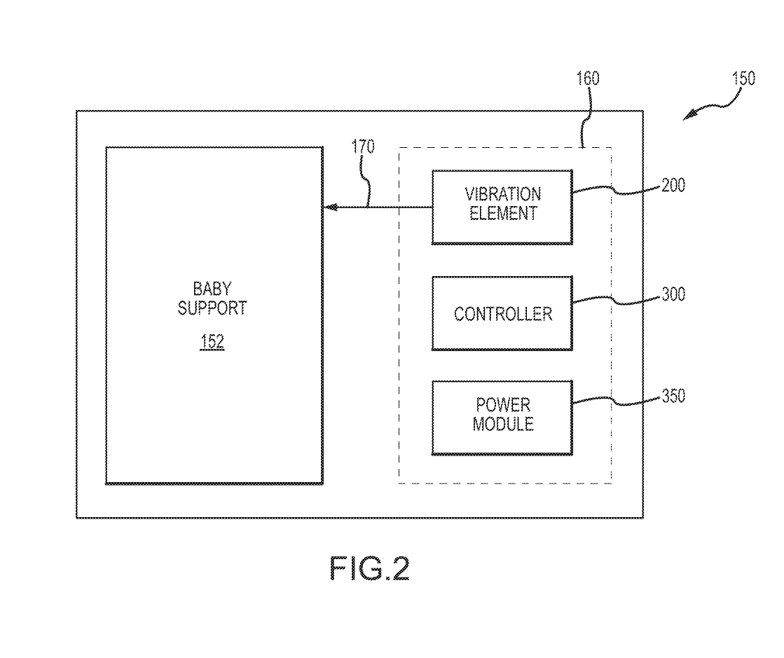

FIG. 2 depicts a baby accessory 150 having a vibration system 160, in accordance with another aspect of the technology. The accessory 150 may be a car seat, a play space, a blanket, a crib, a stroller, or other accessory for holding a baby. The accessory 150 has a baby support area 152 on which the baby is placed. The baby support area may include restraints or may be an accessory where restraint is not desired (for example a crib, play space, or other accessory). The vibration system 160 includes a vibration element 200, a controller 300, and a power module 350, such as a battery, an electrical plug, or a vehicle accessory plug. The vibration system 160 can be integral with or removable from the accessory 150 and is configured to deliver a vibration stimulus 170 to the accessory 150, which vibrates the support area 152.

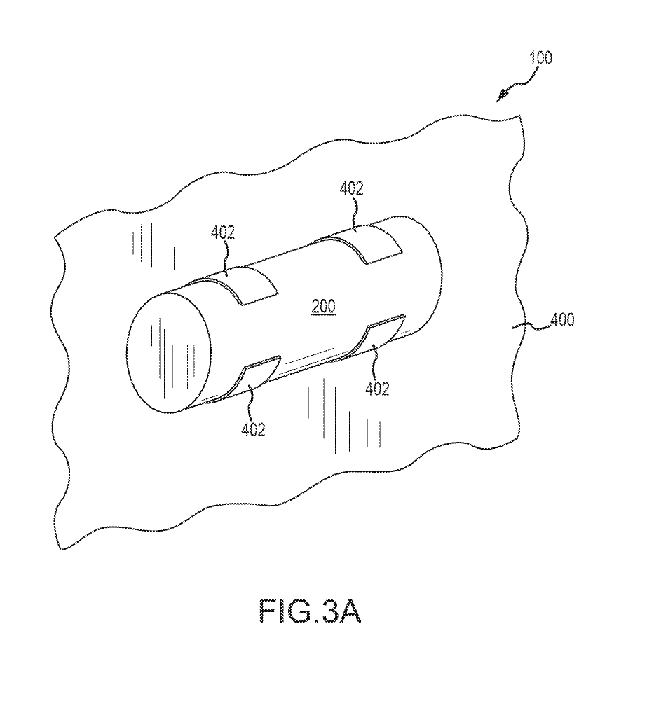

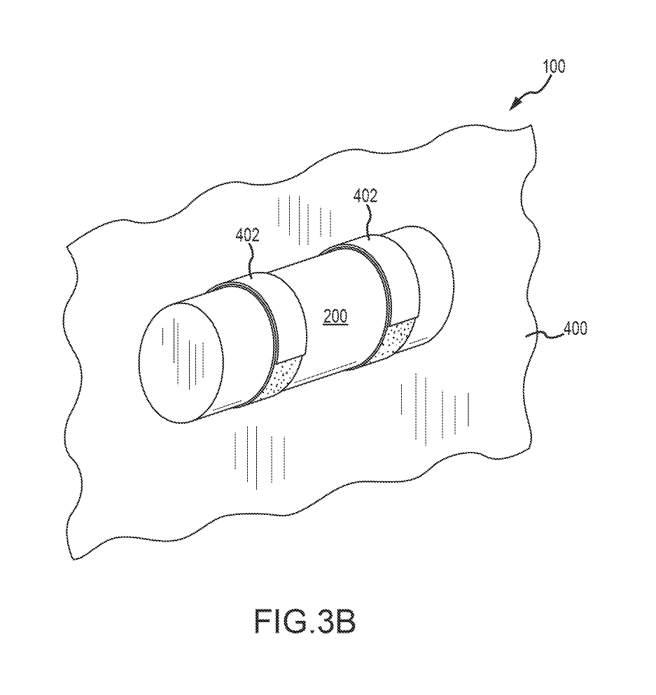

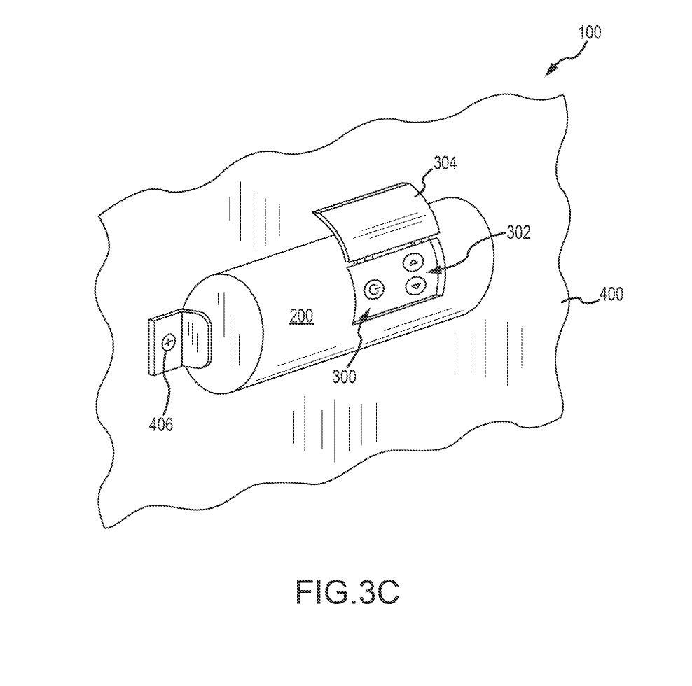

A robust connection between the vibration element 200 and the infant car seat or accessory 100 helps ensure adequate transfer of vibrations and prevents disengagement of the vibration element 200 from the seat 100. Accordingly, various attachment elements may be utilized, as depicted in FIGS. 3A-3C, where a structural element 400 and the vibration element 200 are depicted. Similar attachment mechanisms may also be used to secure the controller to a structure element 400. The structure 400 of the seat may include molded recesses, projections, or brackets 402 that may receive the vibration element 200, as depicted in FIG. 3A. FIG. 3B depicts clamps 404 that can include metal clamps or clips, hook and loop fasteners, etc. In such embodiments, vibration element 200 is releasably engaged with the seat 100, such that a preferred location (particular to the infant) may be identified. FIG. 3C depicts fasteners 406 such as screws, bolts, press-fit, or other mechanical connectors. Chemical fasteners or adhesives may be also be used. Additionally, the cushion portion of the seat may define a recess such that the vibration element may be installed flush with the seat. Although substantially cylindrical vibration elements 200 are depicted herein, vibration elements having other configurations, such as square, elongate, etc., may be utilized. Elongate vibration elements may more evenly distribute vibrations along the car seat 100.

FIG. 2C also depicts an embodiment where the vibration element 200 may include a controller 300 integral therewith. The controller 200 may include one or more dials, buttons, or switches 302 to actuate or control the vibration element 200. These control elements may control the frequency of vibrations as well as an on-off cycle. The various control components may be covered by a removable or movable plastic panel 304 to prevent tampering or inadvertent actuation. Other embodiments may include timers, variable speed controllers, etc.

In addition to a soothing vibration, the vibration element or controller may also have the ability to play soothing infant-appropriate tunes, sounds, or lullabies. Non-skid contact points may be located on the bottom of the seat structure to help ensure that the vibrations do not cause the seat to slide off of a smooth surface.

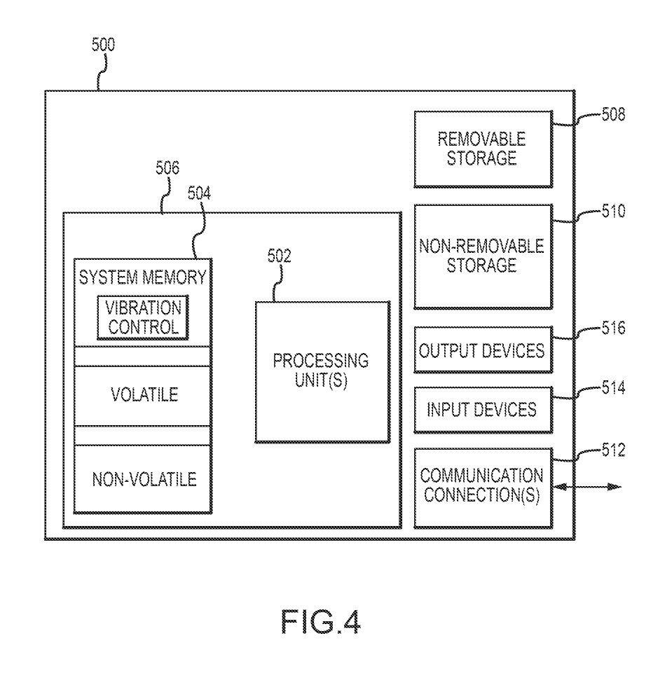

FIG. 4 illustrates one example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like. Such devices may be connected to the controller and/or vibration unit to control operation thereof.

In its most basic configuration, operating environment 500 typically includes at least one processing unit(s) 502 and memory 504. Depending on the exact configuration and type of computing device, memory 504 (instructions to perform secure compression and/or secure decryption) may be volatile (such as RAM), non-volatile (such as ROM, flash memory, etc.), or some combination of the two. Memory 504 may store computer instructions related to controlling the vibration of the system, with regard to timing, frequency, duration, etc. Memory 504 may also store computer-executable instructions that may be executed by the processing unit(s) 502 to perform the methods disclosed herein.

This most basic configuration is illustrated in FIG. 4 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as an Ethernet adaptor, a modem, a Bluetooth adaptor, WiFi adaptor, etc.

Operating environment 500 typically includes at least some form of computer readable media. Computer readable media can be any available media that can be accessed by processing unit(s) 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

1. An apparatus comprising:
an accessory for a child, the accessory comprising at least one structural element;
a vibration element secured to the at least one structural element;
a controller in communication with the vibration element for controlling the vibration element; and
a power source for powering at least one of the controller and the vibration element.

2. The apparatus of claim 1, wherein the accessory comprising a car seat, a play space, a blanket, a crib, and a stroller.

3. The apparatus of claim 1, wherein the vibration element comprises at least one motor.

4. The apparatus of claim 1, wherein the controller is disposed on the vibration element.

5. The apparatus of claim 4, wherein the controller is disposed remote of the vibration element.

6. The apparatus of claim 1, wherein the accessory comprises a controller attachment element for attaching the controller to the accessory.

7. The apparatus of claim 6, wherein the controller is removably attachable to the controller attachment element.

8. The apparatus of claim 1, wherein the accessory comprises a vibration element bracket.

9. The apparatus of claim 8, wherein the vibration element is removably attachable to the vibration element bracket.

10. The apparatus of claim 1, wherein the structure comprises at least one structural element comprises a body, a strut, a handle, a leg, and a base.

11. The apparatus of claim 1, wherein the controller is disposed on an underside of the accessory.

12. The apparatus of claim 1, wherein the controller comprises a timer.

13. The apparatus of claim 1, wherein the controller comprises a variable speed controller.

14. An apparatus comprising:
a car seat adapted to receive a child and to be secured within a passenger compartment of a vehicle;
a motor disposed in the car seat; and
a controller for actuating the motor.

15. The apparatus of claim 14, wherein the controller is disposed in a location of the car seat that is generally inaccessible to the child when the child is received in the car seat.

16. The apparatus of claim 15, wherein the location is at least one of an underside of the car seat, on a handle of the car seat, and remote from the car seat.

17. The apparatus of claim 15, wherein the controller is in communication with the motor via a wireless connection.

18. The apparatus of claim 14, further comprising a battery for providing power to at least one of the controller and the motor.

19. The apparatus of claim 1, wherein the motor is completely inaccessible to the child when the child is received in the car seat.

20. A method of exerting a stimulation on a child disposed in a car seat, the method comprising:
receiving the child in the car seat;
receiving a control signal at a component of the car seat; and
actuating a motor disposed in the car seat.
